(19) United States
(12) Patent Application Publication
(10) Pub. No.: US 2025/0197580 A1
(43) Pub. Date: Jun. 19, 2025

(54) CARBOXYL-TERMINATED BLOWING AGENT AND POLYURETHANE FOAM SYSTEM CONTAINING THE SAME

(71) Applicant: BASF SE, Ludwigshafen Am Rhein (DE)

(72) Inventors: Jian Feng XU, Shanghai (CN); Zu Bao NIE, Shanghai (CN)

(21) Appl. No.: 18/849,784

(22) PCT Filed: Apr. 17, 2023
(86) PCT No.: PCT/EP23/59904

§ 371 Date: Sep. 23, 2024

(30) Foreign Application Priority Data
Apr. 24, 2022 (WO) PCT/CN22/88718

(51) Int. Cl. C08J 9/14; C08J 9/00; C08J 9/12

(52) U.S. Cl. CPC C08J 9/142; C08J 9/0038; C08J 9/125; C08J 9/141; C08J 9/149; C08J 2375/04

(57) ABSTRACT

Disclosed herein is a carboxyl-terminated blowing agent. Also disclosed herein are a polyurethane foam system containing the carboxyl-terminated blowing agent, a polyurethane foam produced from the polyurethane foam system, a composite including the polyurethane foam, and a method of using the composite.

### TECHNICAL FIELD

The present disclosure relates to a carboxyl-terminated blowing agent, a polyurethane foam system containing the same, a polyurethane foam produced from the same. The present disclosure further relates to a composite comprising the polyurethane foam and the use of the composite.

### BACKGROUND

Polyurethane (PU) foams are suitable for many applications, for example cushioning materials, thermal insulation materials, packaging, automobile-dashboards, or construction materials.

During the foaming process of PU foam materials physical and chemical blowing agent are used to achieve a certain material density of the foam. The difference between a physical and a chemical blowing agent is that a physical blowing agent possesses a very high vapor pressure and evaporates during the polyurethane reaction of a polyol, which is present in the A component (C-A) and polyisocyanate, which is present in the B component (C-B).

In most cases the physical blowing agent will be either dissolved in the C-A or separately dosed at the customer side. Since many physical blowing agents have a very high vapor pressure and are additionally flammable, that pre-blending of bigger amounts of blowing agent in the C-A or C-B causes a safety risk. On the other hand, some manufacturers are not equipped to separately add flammable materials safely in the process on their lines. Therefore, only a limited number of manufacturers can handle cyclo-pentane (cP) or n-pentane (nP).

Moreover, conventional blowing agents now widely used in the market are not environmentally friendly. Many blowing agents are comprised of chloro-fluoro-carbons (CFC) or hydrochlorofluorocarbons (HCFC) and these substances are already banded or might be banded in near future due to their contribution to the ozone depletion. A CFC/HCFC-free solution is therefore highly favorable.

HFCs (hydrofluorocarbones) and especially HFOs (hydrofluoroolefines) are physical blowing agents, which are more environmentally friendly. Therefore, they are not banned form the market. But blowing agents like LBA (trans-1-chloro-3,3,3-trifluoropropene) or 245fa (1,1,1,3,3-pentafluoropropane) are not widely accepted in the market due to their price and therefore their market acceptance, e.g., in the very price-driven panel market is not high.

Beside the physical blowing agents, chemical blowing agents are used in PU foam materials. Formic acid (FA) and water (H₂O) for example are the most common chemical blowing agents. FA and H₂O react with an isocyanate-group to form an amine group. During this reaction carbon dioxide (CO₂) is created which will act as the actual blowing agent. The newly created amine-group can further polymerize with another isocyanate-group to form a urea structure. No chain termination occurs during the blow reaction.

The acid group can react with an isocyanate group to an anhydride intermediate and will further react to an amide structure under CO₂ split off. Also, in this case CO₂ will act as the actual blowing agent.

A mono-acid will terminate the polymer chain, while a diacid will extent the chain. A poly-acid will lead to a further cross-linking of the PU structure.

The acid based chemical blowing agent can be added to the C-A, or if the viscosity is suitable, it can be separately added at the line. There are certain diacids and polyacids in the market, but their acceptance is not high due to the fact that they do not offer any additional benefits over the conventional blowing agents, and they are also not cost-competitive. Additionally, some of the diacids and polyacids have stability issues because the compatibility with the C-A is not good.

Nevertheless, the pre-blending of flammable blowing agents with a high vapor pressure is a safety concern. The need to use alternative blowing agents which can be blended in the C-A to be more flexible to supplier also to customers which cannot handle flammable blowing agents or do not have the possibility to add the blowing agent separately at the line.

Therefore, an alternative blowing agent which is solvable in the C-A and does not have any tendency for phase separation in the C-A is therefore highly favorable. Besides a good C-A compatibility, the developed alternative blowing agent brings additional benefits to the resulting foam properties for example a better fire performance and benefits to the processability such as flow of the liquid foam.

U.S. Pat. No. 5,527,876 describes a process for the production of plastics containing amide groups with elimination of CO₂ by reaction of polyfunctional isocyanates, carboxylic acids and, optionally, alcohols in the presence of tertiary amines, more particularly heteroaromatic amines. With this technical solution, low density foams can be produced at low processing temperatures (RT) in the presence of tertiary amines.

EP0711799A2 describes chlorofluorocarbon-free, urethane-containing moldings having a cellular core and an integral skin with an essentially pore-free surface, i.e., polyurethane (PU) integral foams, are produced by reacting the conventional starting components in the presence of blowing agents, catalysts and at least one additive selected from the group consisting of the partially or completely neutralized (1) homopolymers of monoethylenically unsaturated monocarboxylic acids, dicarboxylic acids or the internal anhydrides thereof, (2) copolymers of (2i) monoethylenically unsaturated monocarboxylic acids, dicarboxylic acids or the internal anhydrides thereof and (2ii) carboxyl-free, monoethylenically unsaturated monomers copolymerizable with (2i) and (3) copolymers or graft copolymers of (3i) monoethylenically unsaturated monocarboxylic acids and/or their salts, (3ii) monoethylenically unsaturated dicarboxylic acids, their salts and/or their internal anhydrides and (3iii) if required, carboxyl-free, monoethylenically unsaturated monomers copolymerizable with (3i) and (3ii) in a closed mold with compaction.

WO2021032549A1 describes a polyurethane foam system. The polyol component of the system includes a carboxyl-terminated copolymer of diacid and alcohol as a blowing agent.

One of the shortcomings associated with usage of acid as a blowing agent is that the acid will delay the PU reactivity and influence the final curing. Also, the acid will shorten the shelf life of the A component.

However, these documents fail to show any resulting benefits in term of processing and other properties of the foam, while the present disclosure can clearly show an improvement in the reaction time, foam properties like fire performance, and the processing properties like flowability.

### SUMMARY

An objective of the present disclosure is to overcome the problems of the prior art discussed above and to provide a blowing agent for polyurethane foam that shows good reactivity compared to conventional carboxyl-terminated blowing agent while maintaining physical properties such as density, dimensional stability, or elastic modulus of polyurethane foams produced from polyurethane foam system including the same.

Surprisingly, it has been found by the inventors that the above object can be achieved by a carboxyl-terminated blowing agent represented by Formula (I):

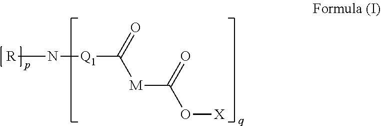

wherein
p is 0 or 1, q is 2 or 3, and the sum of p and q is 3,
each R independently is an alkyl, alkenyl, alkynyl, or aryl group with 1 to 20 carbon atoms,
each Q₁ independently is a polyether moiety consisting of one or more repeating units of alkylene oxide,
each M independently is an alkylene or arylene group with 2 to 10 carbon atoms,
each X independently is hydrogen or a group represented as —[YC(O)MC(O)O]ᵥ—H, wherein each Y independently is a polyether moiety consisting of one or more repeating units of alkylene oxide, and v is an integer from 1 to 12.

According to another aspect of the present disclosure, provided is a polyurethane foam system comprising:
I). a polyol component; and
II). an isocyanate component,
wherein the polyol component comprises
a polyether polyol, a polyester polyol or a mixture thereof;
one or more catalysts; and
at least a blowing agent comprising a carboxyl-terminated copolymer of diacid and alcohol; and
wherein the polyol component includes 5 to 30 wt. % of the carboxyl-terminated blowing agent, wherein the wt. % values are based on the total weight of the polyol component.

In a further aspect, the present disclosure provides a polyurethane foam produced according to the present disclosure.

In another further aspect, the present disclosure provides a composite comprising the polyurethane foam produced according to the present disclosure.

In still another further aspect, the present disclosure provides usage of the composite as a board or a panel in a cleanroom cold storage, a reefer, a roof panel, a laminate; or as a pipe insulation in a spray pipe or an injection pipe.

It has been surprisingly found in this application that, by adding carboxyl-terminated blowing agent in specific amounts into the polyurethane foam system, the polyurethane foam system shows short reaction time, and, at the same time, good mechanical property.

### DETAILED DESCRIPTION

Unless defined otherwise, all technical and scientific terms used herein have the meaning commonly understood by a person skilled in the art to which the present disclosure belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Carboxyl refers to the carboxyl group (—C(O) OH), the functionality in organic carboxylic acids such as acetic acid, oxalic acid, or adipic acid.

Unless otherwise identified, “polyether segment” refers to any bi-valent segment consisting of one or more repeating units of alkylene oxide. The alkylene oxide may include without limitation to tetramethylene oxide, ethylene oxide, propylene oxide, butylene oxide, pentylene oxide, hexylene oxide, or styrene oxide. Polyether segments include without limitation to, e.g., —[CH₂CH₂CH₂CH₂O]ₐ—, —[CH₂CH₂O]_{b}—, —[CH₂CH(CH₃)O]_{c}—, —[CH₂CH₂O]_{d}[CH₂CH(CH₃)O]ₑ—, and/or any other combination of alkylene oxides, wherein a through e are independently an integer not less than 1.

Tetramethylene oxide is —CH₂CH₂CH₂CH₂O—.

Ethylene oxide (EO) is —CH₂CH₂O—.

Propylene oxide (PO) is —CH(CH₃)CH₂O—, or —CH₂CH(CH₃)O—.

Butylene oxide (BO) is —CH(C₂H₅)CH₂O—, —C(CH₃)₂CH₂O—, —CH₂C(CH₃)₂O—, —CH(CH₃)CH(CH₃)O—, or —CH₂CH(C₂H₅)O—.

Pentylene oxide is —CH(C₃H₇)CH₂O—, —CH₂CH(C₃H₇)O—, —CH(C₂H₅)CH(CH₃)O—, —CH(CH₃)CH(C₂H₅)O—, —C(CH₃)(C₂H₅)CH₂O—, —CH₂C(CH₃)(C₂H₅)O—, —C(CH₃)₂CH(CH₃)O—, or —CH₂(CH₃)C(CH₃)₂O—.

Hexylene oxide is —CH(C₄H₉)CH₂O—, —CH₂CH(C₄H₉)O—, —C(C₃H₇)(CH₃) CH₂O—, —CH₂C(C₃H₇)(CH₃)O—, —CH(C₃H₇)CH(CH₃) O, —CH(CH₃)CH(C₃H₇)O—, —C(C₂H₅)(C₂H₅)CH₂O—, —CH₂C(C₂H₅)₂O—, —CH(C₂H₅)CH(C₂H₅)O—, —C(CH₃)₂CH(C₂H₅)O—, —CH(C₂H₅)C(CH₃)₂O—, or —CH(CH₃)₂C(CH₃)₂O—.

Styrene oxide is —CH(C₆H₅)CH₂O— or —CH₂CH(C₆H₅)O—.

Acid number is the mass of potassium hydroxide (KOH) in milligrams that is required to neutralize one gram of a chemical substance. Acid number can be determined by titration and is calculated as below,

$$acid number = \frac{{F}_{n}}{{M}_{n}} \times 56100 g / mol$$

Fₙ is defined as the functionality, i.e., the number of carboxylic groups per molecule.

Mₙ is defined as the number average of the molecular weight.

Isocyanate index or NCO index is defined as the ratio of number of NCO groups over number of isocyanate-reactive hydrogen atoms present in a formulation, given as a percentage:

Isocyanate index=[NCO]×100(%)/[active hydrogen]

In other words, the isocyanate index expresses the percentage of isocyanate actually used in a formulation with respect to the amount of isocyanate theoretically required for reacting with the amount of isocyanate-reactive hydrogen used in a formulation.

Unless otherwise identified, the temperature refers to room temperature and the pressure refers to ambient pressure.

Unless otherwise identified, the solvent refers to all organic and inorganic solvents known to the persons skilled in the art and does not include any type of monomer molecular.

### Blowing Agents

The blowing agents in the present disclosure comprises a carboxyl-terminated blowing agent represented by Formula (I):

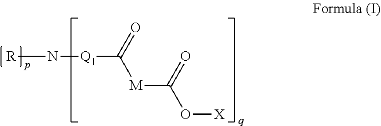

wherein
p is 0 or 1, q is 2 or 3, and the sum of p and q is 3,
each R independently is an alkyl, alkenyl, alkynyl, or aryl group with 1 to 20 carbon atoms,
each Q₁ independently is a polyether moiety consisting of one or more repeating units of alkylene oxide,
each M independently is an alkylene or arylene group with 2 to 10 carbon atoms,
each X independently is hydrogen or a group represented as [YC(O)MC(O)O]ᵥ—H, wherein Y represent a polyether moiety consisting of one or more repeating units of alkylene oxide, and v is an integer from 1 to 12.

In some embodiments, each M independently is a linear or branched alkyl group with 2 to 8 carbon atoms, more preferably a linear or branched alkyl group with 2 to 6 carbon atoms, still more preferably a linear or branched alkyl group with 3 to 5 carbon atoms. In another embodiments, each M independently is a phenylene (—C₆H₄—) group, e.g., p-phenylene, o-phenylene, or m-phenylene, or a naphthalenediyl group.

In some embodiments, each Q₁ independently is a polyether moiety consisting of 1 to 10 repeating units selected from the group consisting of tetramethylene oxide, ethylene oxide, propylene oxide, butylene oxide, and styrene oxide.

In some embodiments, each X independently is -(EO)ₙ[(C(O)CH₂CH₂CH₂CH₂C(O)O(EO)ₙ]ₒC(O)CH₂CH₂CH₂CH₂C(O)OH, wherein, EO is ethylene oxide, n is an integer from 1 to 10, and o is an integer from 0 to 10.

In some embodiments, the carboxyl-terminated blowing agent has an acid number of 60 to 200 mgKOH/g.

In some embodiments, the molecular weight of the carboxyl-terminated blowing agent is from 200 to 2000 g/mol, preferably from 400 to 1500 g/mol, more preferably from 500 to 1200 g/mol.

The carboxyl-terminated blowing agent can be prepared by reacting a N-containing alcohol represented by Formula (II) and a dicarboxylic acid represented by Formula (III), an anhydride thereof, or a mixture of the dicarboxylic acid represented by Formula (III) and an anhydride thereof, optionally in presence of an alcohol with at least two hydroxyl groups represented by Formula (IV). The polymerization process is an esterification in the presence of excessive dicarboxylic acid and/or anhydride of dicarboxylic acid.

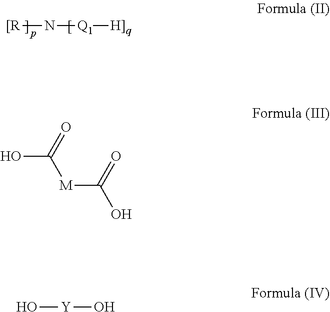

p is 0 or 1, q is 2 or 3, and the sum of p and q is 3,
each R independently is an alkyl, alkenyl, alkynyl, or aryl group with 1 to 20 carbon atoms,
each Q₁ independently is a polyether moiety consisting of one or more repeating units of alkylene oxide,
each M independently is an alkylene or arylene group with 2 to 10 carbon atoms, and
each Y is independently a polyether moiety consisting of one or more repeating units of alkylene oxide.

In some embodiments, each M independently is an alkylene group with the formula —CₘH₂ₘ—, wherein m is an integer from 2 to 10. M may be, for example, ethylene group (—C₂H₄—) or propylene group (—CH₂CH₂CH₂— or —CH(CH₃)CH₂—). In some embodiments, each M independently is a phenylene (—C₆H₄—) group, e.g., p-phenylene, o-phenylene, or m-phenylene, or a naphthalenediyl group.

In some embodiments, Q₁ is ethylene oxide or propylene oxide.

In some embodiments, p is 0 and the nitrogen atom is connected to three polyether moieties.

The reaction among the N-containing alcohol, the carboxylic acid/anhydride of the carboxylic acid, and optionally the alcohol with at least two hydroxyl groups can be conducted in a one-pot manner, i.e., all the starting materials are mixed and heated.

The N-containing alcohol can be commercially available from various manufacturers or produced by reacting organic amine or ammonia with one or more alkylene oxides. Examples can include triethanolamine, triisopropanolamine, ethoxylates or propoxylates of triethanolamine or triisopropanolamine, ethoxylates or propoxylates of methylamine, ethylamine, propylamine, stearylamine, or aniline, or any other alkoxylated amine.

In some embodiments, the N-containing alcohol is represented by Formula (V):

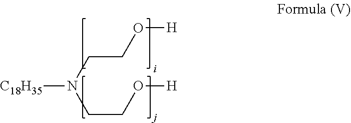

The alcohol represented by Formula (V) can be synthesized by reacting stearylamine with excessive ethylene oxide under presence of catalysts.

The dicarboxylic acid includes without limitation to succinic acid, glutaric acid, adipic acid, pimelic acid, suberic acid, azelaic acid, sebacic acid, undecanedioic acid, dodecanedioic acid, phthalic acid, isophthalic acid, terephthalic acid, 1,4-naphthalenedicarboxylic acid, 1,8-naphthalenedicarboxylic acid, 2,3-naphthalenedicarboxylic acid, and 2,6-naphthalenedicarboxylic acid, in which diacid is preferably adipic acid.

In some embodiments, the dicarboxylic acid is a mixture of two or more dicarboxylic acids.

The anhydride of dicarboxylic acid includes without limitation to anhydrides of succinic acid, glutaric acid, adipic acid, pimelic acid, suberic acid, azelaic acid, sebacic acid, undecanedioic acid, dodecanedioic acid, phthalic acid, isophthalic acid, terephthalic acid, 1,4-naphthalenedicarboxylic acid, 1,8-naphthalenedicarboxylic acid, 2,3-naphthalenedicarboxylic acid, and 2,6-naphthalenedicarboxylic acid, etc.

In some embodiments, the anhydride is a mixed anhydride of two or more dicarboxylic acids.

In some embodiments, the anhydride is a mixture of two or more anhydrides of dicarboxylic acids.

In some embodiments, a mixture of a dicarboxylic acid and an anhydride of the same or different dicarboxylic acid can be used.

To prepare the carboxyl-terminated blowing agent, the alcohol with at least two hydroxyl groups can include one or more diols, triols, tetraols, etc.

Suitable diols include ethylene glycol, propylene glycol, butylene glycol, or a polyether diol. The polyether diol is a diol-terminated polyether consisting of one or more repeating units selected from ethylene oxide, propylene oxide, and butylene oxide. The polyether diol includes diethylene glycol, triethylene glycol, polyethylene glycol, dipropylene glycol, tripropylene glycol, polypropylene glycol, etc. They can be commercially available from various manufacturers. Suitable triols include triethanolamine, glycerin or trimethylolpropane or modifications of the before mentioned components with an alkoxylation degree of up to 10. Suitable tetraols include threitol, erythritol, pentaerythritol, hexane-2,3,4,5-tetraol, or modifications of the before mentioned components with an alkoxylation degree of up to 10.

When preparing the carboxyl-terminated blowing agent, the stoichiometry needs to be controlled so that the carboxylic groups are in excess with respect to the hydroxyl groups in both the N-containing alcohol and the alcohol with at least two hydroxyl groups. Without bound by any theory, the carboxylic groups can react with the hydroxyl groups and form ester linkage in the blowing agent. The number of carboxylic groups in the dicarboxylic acid is larger than the sum of the number of hydroxyl groups in the N-containing alcohol and the number of hydroxyl groups in the alcohol with at least two hydroxyl groups. The excessive carboxylic groups thus are left in the ends of the blowing agent. The terminal carboxylic groups are key to the chemical foaming process of polyurethane as they can react with isocyanates and release CO₂ in-situ.

In further embodiments, the carboxyl-terminated blowing agent could be used solo or combined with other blowing agents. The other blowing agents include physical blowing agents such as alkane (for example pentane), fluorocarbons, hydrofluorocarbons, chlorocarbons, chlorofluorocarbons, hydrochlorofluorocarbons and chemical blowing agents such as water.

### Polyurethane Foam System

To prepare a polyurethane foam, the carboxyl-terminated blowing agent according to the present disclosure is present in a polyurethane foam system. In various embodiments, the polyurethane foam system comprises a polyol component and an isocyanate component, wherein the polyol component comprises
a polyether polyol, a polyester polyol or a mixture thereof;
one or more catalysts; and
at least one blowing agent, wherein the blowing agent comprises a carboxyl-terminated blowing agent;
wherein the polyol component includes 5 to 30 wt. % of the carboxyl-terminated blowing agent, wherein the wt. % values are based on the total weight of the polyol component.

In some embodiments, the polyol component includes 6 wt % to 25 wt %, preferably 7 wt % to 20 wt %, more preferably 8 wt % to 15 wt %, of the carboxyl-terminated blowing agent, based on a total weight of the polyol component.

Preparation of the polyurethane foams has been described elsewhere, but basically involves reaction of polyol and a catalyst with an isocyanate in the presence of a blowing agent.

### Polyol Component

The polyol component includes a polyether polyol, a polyester polyol or a mixture thereof; one or more catalysts; and at least one blowing agent, wherein the blowing agent comprising a carboxyl-terminated blowing agent.

In some embodiments, the polyol component includes 5 wt % to 30 wt %, preferably 6 wt % to 25 wt %, still preferably 7 wt % to 20 wt %, more preferably 8 wt % to 15 wt %, of a carboxyl-terminated blowing agent, based on a total weight of the polyol component.

In some embodiments, the blowing agent further comprises one or more chemical blowing agents and/or physical blowing agents.

Optionally, the polyol component may further include a chain extender or crosslinking agent; a flame retardant; and one or more additives and/or auxiliaries.

### Polyether Polyols and Polyester Polyols

Polyether polyols and polyester polyols are collective known as polyols. Polyol refers to a polyhydroxy compound. Preferably, polyhydroxy compounds having a functionality of 2 to 8, more preferably 3 to 6, and a hydroxyl number of 150 to 850, more preferably 200 to 600 are examples of higher molecular weight compounds having at least two reactive hydrogen atoms.

For example, polythioether polyols, polyester amides, polyacetals containing hydroxyl groups, aliphatic polycarbonates containing hydroxyl groups, and preferably, polyester polyols and polyether polyols. In addition, mixtures of at least two of the aforesaid polyhydroxy compounds can be used as long as these have an average hydroxyl number in the aforesaid range.

Suitable polyester polyols can be produced, for example, from organic dicarboxylic acids with 2 to 12 carbons, preferably aliphatic dicarboxylic acids with 4 to 6 carbons, and multivalent alcohols, preferably diols, with 2 to 12 carbons, preferably 2 to 6 carbons. Examples of dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids can be used individually or in mixtures. Instead of the free dicarboxylic acids, the corresponding dicarboxylic acid derivatives may also be used such as dicarboxylic acid mono- or di-esters of alcohols with 1 to 4 carbons, or dicarboxylic acid anhydrides. Dicarboxylic acid mixtures of succinic acid, glutaric acid and adipic acid in quantity ratios of 20-35:35-50:20-32 parts by weight are preferred, especially adipic acid. Examples of divalent and multivalent alcohols, especially diols, include ethanediol, diethylene glycol, 1,2- and 1,3-propanediol, dipropylene glycol, 1,4-butanediol, 1,5-pentanediol, 1,6-hexanediol, 1,10-decanediol, glycerin, and trimethylolpropane. Glycol, diethylene glycol, 1,4-butanediol, 1,5-pentanediol, 1,6-hexanediol, or mixtures of at least two of these diols are preferred, especially mixtures of 1,4-butanediol, 1,5-pentanediol and 1,6-hexanediol.

The polyester polyols can be produced by polycondensation of organic polycarboxylic acids, e.g., aromatic or preferably aliphatic polycarboxylic acids and/or derivatives thereof and multivalent alcohols in the absence of catalysts or preferably in the presence of esterification catalysts, preferably in an atmosphere of inert gases, e.g., nitrogen, carbon dioxide, helium, argon, etc., in the melt at temperatures of 150° C. to 250° C., preferably 180° C. to 220° C., optionally under reduced pressure, up to the desired polymerization degree, which is preferably less than 10, especially less than 5. In a preferred embodiment, the esterification mixture is subjected to polycondensation at the temperatures mentioned above up to an acid value of 80 to 30, preferably 40 to 30, under normal pressure and then under a pressure of less than 500 mbar, preferably 50 to 150 mbar. Examples of suitable esterification catalysts include iron, cadmium, cobalt, lead, zinc, antimony, magnesium, titanium and tin catalysts in the form of metals, metal oxides or metal salts. However, the polycondensation may also be per formed in liquid phase in the presence of diluents and/or entraining agents such as benzene, toluene, xylene or chlorobenzene for azeotropic distillation of the water of condensation.

To produce the polyester polyols, the organic polycarboxylic acids and/or derivatives thereof and multi valent alcohols are preferably polycondensed in a mole ratio of 1:1-1.8, preferably 1:1.05-1.2.

The resulting polyester polyols preferably have a functionality of 2 to 3, and a hydroxyl number of 150 to 500, and especially 200 to 400.

Polyether polyols, which can be obtained by known methods, may also be used as the polyhydroxy compounds. For example, polyether polyols can be produced by anionic polymerization with alkali hydroxides such as sodium hydroxide or potassium hydroxide or alkali alcoholates, such as sodium methylate, sodium ethylate or potassium ethylate or potassium isopropylate as catalysts and with the addition of at least one initiator molecule containing 2 to 8, preferably 3 to 8, reactive hydrogens or by cationic polymerization with Lewis acids such as antimony pentachloride, boron trifluoride etherate, etc., or bleaching earth as catalysts from one or more alkylene oxides with 2 to 4 carbons in the alkylene radical.

Suitable cyclic ethers and alkylene oxides include, for example, tetrahydrofuran, 1,3-propylene oxide, 1,2- and 2,3-butylene oxide, styrene oxide, and preferably ethylene oxide and 1,2-propylene oxide. The alkylene cyclic ethers and oxides may be used individually, in alternation, one after the other or as a mixture. Examples of suitable initiator molecules include water, organic dicarboxylic acids such as succinic acid, adipic acid, phthalic acid and terephthalic acid, aliphatic and aromatic, optionally N-mono-, N, N-, and N,N′-dialkyl substituted diamines with 1 to 4 carbons in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5-, and 1,6-hexamethylenediamine, phenylenediamines, 2,3-, 2,4- and 2,6-toluenediamine and 4,4′-, 2,4′-, and 2,2′-diaminodiphenylmethane.

Suitable initiator molecules also include alkanolamines such as ethanolamine, diethanolamine, N-methyl- and N-ethyl ethanolamine, N-methyl- and N-ethyl diethanolamine and triethanolamine plus ammonia.

Multivalent alcohols, especially divalent and/or trivalent alcohols are preferred such as ethanediol, 1,2-propanediol and 1,3-propanediol, diethylene glycol, dipropylene glycol, 1,4-butanediol, 1,6-hexanediol, glycerin, trimethylolpropane, pentaerythritol, sorbitol, and sucrose.

The polyether polyols have a functionality of preferably 3 to 8 and especially 3 to 6 and have a hydroxyl number of 300 to 850, preferably 350 to 800.

Also suitable as polyether polyols are melamine polyether polyol dispersions according to U.S. Pat. No. 4,293,657; polymer polyether polyol dispersions prepared from polyepoxides and epoxide resin hardeners in the presence of polyether polyols according to U.S. Pat. No. 4,305,861; dispersions of aromatic polyesters in polyhydroxy compounds according to U.S. Pat. No. 4,435,537; dispersion of organic and/or inorganic fillers in polyhydroxy compounds according to U.S. Pat. No. 4,243,755; polyurea polyether polyol dispersions according to DE A 31 2 402, tris-(hydroxyalkyl) isocyanurate polyether polyol dispersions according to U.S. Pat. No. 4,514,526 and crystallite suspensions according to U.S. Pat. No. 4,560,708, whereby the details in the aforesaid patents are to be regarded as part of the patent disclosure, and are herein incorporated by reference.

Like the polyester polyols, the polyether polyols may be used either individually or in the form of mixtures. Furthermore, they can be mixed with the aforesaid dispersions, suspensions, or polyester polyols as well as the polyester amides containing hydroxyl groups, the polyacetals, and/or polycarbonates.

Examples of hydroxyl group-containing polyacetals that can be used include, for example, the compounds that can be produced from glycols such as diethylene glycol, triethylene glycol, 4,4′-dihydroxyethoxydiphenyldimethylmethane, hexanediol and formaldehyde. Suitable polyacetals can also be produced by polymerization of cyclic acetals.

Suitable hydroxyl group-containing polycarbonates include those of the known type such as those obtained by reaction of diols, e.g., 1,3-propanediol, 1,4-butanediol, and/or 1,6-hexanediol, diethylene glycol, triethylene glycol or tetraethylene glycol and diaryl carbonates, e.g., diphenyl carbonate, or phosgene.

The polyester amides include the mainly linear condensates obtained from multivalent saturated and/or unsaturated carboxylic acids and their anhydrides and amino alcohols, or mixtures of multivalent alcohols and amino alcohols and/or polyamines.

### Catalysts

The catalyst used in the present disclosure may include one or more selected from the group consisting of amine-based catalysts and metal-based catalysts. The catalysts can greatly accelerate the reaction of the hydroxyl group containing compounds of components and optionally with the polyisocyanates.

The metal-based catalyst may include an organic tin compound such as tin (II) salts of organic carboxylic acids, e.g., tin (II) acetate, tin (II) octanoate, tin (II) ethylhexanoate and tin (II) laurate, and dialkyltin (IV) salts of organic carboxylic acids, e.g., dibutyltin diacetate, dibutyltin diacetate, dibutyltin dilaurate, dibutyltin maleate, and dioctyltin diacetate. The metal-based catalyst may include a potassium compound selected from a group consisting of potassium hydroxide, potassium carbonate, potassium bicarbonate, potassium benzoate, potassium formate, potassium acetate, potassium propionate, potassium butyrate, potassium valerate, potassium caproate, potassium caprylate, potassium 2-ethylhexanoate, potassium neodecanoate, potassium caprate, potassium salicylate, potassium laurate, potassium oleate, potassium maleate, potassium citrate, potassium oxalate, potassium methoxide, potassium cellulose, potassium carboxymethylcellulose, potassium hyaluronate, potassium alginate, potassium gluconate and any combination thereof.

Examples of the amine-based catalysts may include amines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N, N,N′N′-tetramethylethylenediamine, N,N,N′,N′-tetraymethylbutanediamine, or -hexanediamine, pentamethyldiethylenetriamine, tetramethyldiaminoethyl ether, bis(dimethylaminopropyl) urea, dimethylpiperazine, 1,2-dimethylimidazole, 1-azabicyclo[3.3.0]octane and preferably 1,4-diaza-bicyclo[2.2.-2]octane and alkanolamine compounds such as triethanolamine, triisopropanolamine, N-methyl- and N-ethyldiethanolamine and dimethylethanolamine.

Suitable catalysts include tris-(dialkylamino-s-hexahydrotriazines, especially tris(N,N-dimethylaminopropyl)-s-hexahydrotriazine, tetraalkylammonium hydroxides such as tetramethylammonium hydroxide, alkali hydroxides such as sodium hydroxide and alkali alcoholates such as sodium methylate and potassium isopropylate as well as alkali salts of long chain fatty acids with 10 to 20 carbon atoms and optionally OH dependent groups. A particular catalyst or combination of catalysts may be chosen by one skilled in the art.

### Chain Extenders and Crosslinking Agents

The polyurethane foams can be prepared with or without using chain extenders and/or crosslinking agents. Suitable chain extenders and/or crosslinking agents include preferably alkanolamines, more preferably diols and/or triols. Typical examples are alkanolamines such as ethanolamine and/or isopropanolamine; dialkanolamines, such as diethanolamine, N-methyl-, N-ethyldiethanolamine, diisopropanolamine; trialkanolamines such as triethanolamine, triisopropanolamine; and the addition products from ethylene oxide or 1,2-propylene oxide, and alkylenediamines having 2 to 6 carbon atoms in the alkylene radical such as N,N′-tetra(2-hydroxyethyl)-ethylenediamine and N,N′-tetra(2-hydroxypropyl)ethylenediamine, aliphatic, cycloaliphatic and/or araliphatic diols having 2 to 14, more preferably 4 to 10 carbon atoms such as ethylene glycol, 1,3-propanediol, 1,10-decanediol, o-, m-, p-dihydroxycyclohexane, diethylene glycol, dipropylene glycol, and preferably 1,4-butanediol, 1,6-hexanediol, and bis(2-hydroxyethyl) hydroquinone; triols such as 1,2,4- and 1,3,5-trihydroxycyclohexane, glycerin and trimethylolpropane; and lower molecular weight hydroxyl group containing polyalkylene oxides, based on ethylene oxide and/or 1,2-propylene oxide and aromatic diamines such as toluenediamines and/or diaminodiphenylmethanes as well as the aforesaid alkanolamines, diols, and/or triols as initiator molecules.

If chain extenders, crosslinking agents, or mixtures thereof are used in the preparation of polyurethane foams, then advantageously these are used in a quantity of from up to 20 wt. %, more preferably 2 to 10 wt. %, based on the weight of the polyol component.

### Flame Retardants

The polyol component may optionally include a flame retardant. Flame retardant comprises at least one phosphorus-containing flame retardant which is a derivative of phosphoric acid, polyphosphoric acid, phosphonic acid, and/or phosphinic acid.

Suitable flame retardants for the purposes of the present disclosure are preferably liquid organic phosphorus compounds such as halogen-free organic phosphates such as triethyl phosphate (TEP), halogenated phosphates, for example tris(1-chloro-2-propyl)phosphate (TCPP) and tris(2-chloroethyl)phosphate (TCEP), and organic phosphonates such as dimethyl methylphosphonate (DMMP), dimethyl propane phosphonate (DMPP), or solids such as ammonium polyphosphate (APP) and red phosphorus. Furthermore, besides the phosphorus-containing flame retardant, halogenated compounds, for example, halogenated polyols, as well as solids, such as expanded graphite and melamine are suitable as an auxiliary flame retardant.

### Other Additives and Auxiliaries

Optionally other additives and/or auxiliaries may be incorporated into the polyol component to produce the polyurethane foam. Examples include surfactants, foam stabilizers, cell regulators, fillers, dyes, pigments, hydrolysis preventing agents, fungistatic and bacteriostatic agents.

Examples of suitable surfactants are compounds which serve to support homogenization of the starting materials and may also regulate the cell structure of the plastics. Specific examples are salts of sulfonic acids, e.g., alkali metal salts or ammonium salts of fatty acids such as oleic or stearic acid, of dodecylbenzene- or dinaphthylmethanedisulfonic acid, and ricinoleic acid; foam stabilizers, such as siloxane-oxyalkylene copolymers and other organopolysiloxanes, oxyethylated alkyl-phenols, oxyethylated fatty alcohols, paraffin oils, castor oil esters, ricinoleic acid esters, Turkey red oil and groundnut oil, and cell regulators, such as paraffins, fatty alcohols, and dimethylpolysiloxanes. The surfactants are usually used in amounts of 0.01 to 5 parts by weight, based on 100 parts by weight of the polyol component. Furthermore, the oligomeric acrylates with polyoxyalkylene and fluoroalkane side groups are also suitable for improving the emulsifying effect, the cell structure and/or for stabilizing the foam. These surfactants are generally used in amounts of 0.01 to 5 wt. % based on the weight of the polyol component. For example, fillers are conventional organic and inorganic fillers and reinforcing agents. Specific examples are inorganic fillers, such as silicate minerals, for example, phyllosilicates such as antigorite, serpentine, hornblendes, amphiboles, chrysotile, and talc; metal oxides, such as kaolin, aluminum oxides, titanium oxides and iron oxides; metal salts, such as chalk, baryte and inorganic pigments, such as cadmium sulfide, zinc sulfide and glass, inter alia; kaolin (china clay), aluminum silicate and coprecipitates of barium sulfate and aluminum silicate, and natural and synthetic fibrous minerals, such as wollastonite, metal, and glass fibers of various lengths. Examples of suitable organic fillers are carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and in particular, carbon fibers. The inorganic and organic fillers may be used individually or as mixtures and may be introduced into the polyol component or isocyanate side in amounts of from 0.5 to 40 percent by weight, based on the weight of components (the polyols and the isocyanate).

### Isocyanate Component

The isocyanate component in the present disclosure comprises one or more selected from the group consisting of aliphatic, cycloaliphatic, araliphatic, and aromatic isocyanates. For example, the isocyanate component may include alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′, 2,2′-, and 2,4′-dicyclohexylmethane diisocyanate as well as the corresponding isomeric mixtures and preferably aromatic diisocyanates and polyisocyanates such as 2,4- and 2,6-toluene diisocyanate and the corresponding isomeric mixtures 4,4′-, 2,4′-, and 2,2′-diphenylmethane diisocyanate and the corresponding isomeric mixtures, mixtures of 4,4′- and 2,4′-diphenylmethane diisocyanates and polyphenylenepolymethylene polyisocyanates (polymeric MDI), as well as mixtures of polymeric MDI and toluene diisocyanates. The organic di and polyisocyanates can be used individually or in the form of mixtures.

The polyurethane foams of the present disclosure can be prepared with the help of conventional mixing equipment. The method includes providing polyol component; providing isocyanate component; and reacting the polyol component and the isocyanate component in a weight ratio such that the isocyanate index is from 150 to 500, preferably from 200 to 450, more preferably from 230 to 400.

It should be observed that the isocyanate index as used herein is considered from the point of view of the actual foaming process involving the isocyanate ingredients and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g., reacted with isocyanate to produce modified polyols or polyamines) are not taken into account in the calculation of the isocyanate index. Only the free isocyanate groups and the free isocyanate-reactive hydrogens (including those of the water) present at the actual foaming process are taken into account.

### Applications

The polyurethane foam according to the present disclosure may be included in a composite. The composite may comprise the polyurethane foam as a core layer.

For example, the composite may be a sandwich panel. The sandwich panel may include the polyurethane foam as its core layer. The sandwich panel may include metal layer as outer layer(s).

The composite may be used in various fields, such as boards or panels in the application of cleanroom cold storage, reefer, roof panels, laminate, or insulation boards, or as pipe insulation in the field of spray pipe applications and injection pipes.

### EXAMPLES

### Measuring and Test Methods

The measuring and test methods are shown in Table 1.

TABLE 1
Measuring and test standards

| Property | Unit | Testing standard |
|---|---|---|
| Density | g/L | DIN EN ISO 845: 2006 |
| Compressive strength | N/mm² | ISO 844: 2014 |
| Elastic modulus | MPa | ISO 527-2/DIN 53455 |
| Dimensional stability at 80° C. | % | DIN EN 1604: 2007 |
| thermal conductivity | mW/(m*K) | EN 12667 |
| Proportion of close cells | % | EN ISO 4590 |
| Tensile strength | N/mm2 | DIN EN 1607: 2013 |
| Water absorption | % | GB/T 8810-2005 |
| Flow | cm/g | Internal |
| Fire test B2 | cm | DIN 4102-1: 1998 |
| Limiting Oxygen Index (LOI) | % | ISO 4589-2: 2017 |
| Gel time | s | Annex E of EN 14315-1 |

Gel time refers to the time between the start of mixing and the time at which long “strings” or tacky material can be pulled from the interior of the rising mass by inserting and withdrawing a wooden stick.

The proportion of closed cells was determined with an ACCUPYC 1330 pycnometer in accordance with European standard EN ISO 4590.

Moreover, the Flow property is measured as follows: Liquid foam was applied in a flow mold with the size 100 cm*15 cm*3 cm. The liquid foam was placed at one end of the flow mold. During the reaction, the temperature in the mold was kept constantly at 57° C. for 30 min. After keeping the foam in the mold for 30 min, the cured foam was removed from the mold. The average length expansion of the foam and weight of the foam is measured. Afterwards the ratio between length and weight is calculated to determine the flow in cm/g of each polyurethane foam system. Therefore, the bigger the calculated ratio the better the flowability of the liquid foam.

### Materials

The materials used in the examples are as follows.

Polyol 1, phthalic anhydride-based polyester polyol (PO based) with glycerin-EO as starter, an OH value of 240 mg KOH/g.

Polyol 2, polyether polyol (PO based) with sorbitol as starter, an OH value of 490 mg KOH/g.

Acid A1, esterification product of adipic acid and diethylene glycol, acid number 180-190 mgKOH/g, with a functionality of 2.

Acid A2, esterification product of adipic acid and AC1812 (26635-92-7), acid number 100-110 mgKOH/g, with a functionality of 2.

Acid A3, esterification product of adipic acid, diethylene glycol, and AC1812, acid number 160-170 mgKOH/g, with a functionality of 2.

Acid A4, esterification product of adipic acid and triethanolamine, acid number 310 mgKOH/g, with a functionality of 3.

Cyclopentane, referred to as “c-pentane”, CAS No. 287-92-3, from BASF.

N-pentane, referred to as “n-pentane”, CAS No. 287-92-3, from BASF.

Adipic acid, CAS No. 124-04-9, from BASF.

Diethylene glycol, CAS No. 111-46-6, from BASF.

AC1812, N-polyoxyethylated-N-octadecylamine, CAS No. 26635-92-7, from BASF.

Triethanolamine, CAS No. 102-71-6, from BASF.

PMDI, 4,4′-diphenylmethane diisocyanate (MDI) containing oligomers of high functionality and isomers, Lupranat® M 20 S from BASF.

2-hydroxypropyl trimethylammonium formate, abbreviated hereinafter as “HPTAF”, CAS No. 62314-25-4, used as catalyst.

(2-((2-(dimethylamino)ethyl)methylamino) ethanol from BASF, abbreviated hereinafter as “DMAEMAE”, CAS No. 2212-32-0, used as catalyst.

Polycat® 46 from Evonik is potassium acetate in ethylene glycol, CAS No. 127-08-2, used as catalyst.

### Synthesis of the Acid A1 (Two-Functionality)

The chemical pathway to synthesize this chemical is a copolymer/esterification of adipic acid and diethylene glycol. Both monomers were copolymerized in a molar ratio of adipic acid:DEG as 2:1 to make sure that all chain ends are end-capped with adipic acid. The reaction was catalyzed with 0.0025 wt % of titanium butoxide (TTB). The reaction mixture was heated in a reactor slowly up to 200° C. under water separator. Afterward the temperature was maintained at 200° C. and the water separation was continued. After approximately 5 hours in total (heating and maintaining the temp. at 200° C.) and after the right acid number was achieved the vacuum was released and the product was cool down to room temperature.

### Synthesis of the Acid A2 (Two-Functionality)

The chemical pathway to synthesize this chemical is a copolymer/esterification of adipic acid and AC1812. Both monomers were copolymerized in a molar ratio of a molar ratio of adipic acid:AC1812 as 2:1. The reaction was catalyzed with 0.03 wt % of TTB, based on a total weight of the adipic acid and AC1812. The reactor was fitted with a Vigreux column and a Dean-Stark type condenser to collect the condensation product. During the first half of the synthesis, the setup was continuously flushed with nitrogen gas to limit oxidation and facilitate transport of water vapor. While stirring, the mixture was heated to 120° C. using a heating mantle. The catalyst was added when the temperature of the mixture reached 120° C. The reaction temperature was increased stepwise to maintain distillation of the formed by-products. After 8 h at 230° C. the product was left to cool and discharged from the reactor.

### Synthesis of the Acid A3 (Two-Functionality)

The chemical pathway to synthesize this chemical is a copolymer/esterification of adipic acid, diethylene glycol, and AC1812. All monomers were copolymerized in a molar ratio of adipic acid:AC1812:diethylene glycol as 4:1:1. The reaction was catalyzed with 0.03 wt % of TTB. The reactor was fitted with a Vigreux column and a Dean-Stark type condenser to collect the condensation product. During the first half of the synthesis, the setup was continuously flushed with nitrogen gas to limit oxidation and facilitate transport of water vapor. While stirring, the mixture was heated to 120° C. using a heating mantle. The catalyst was added when the temperature of the mixture reached 120° C. The reaction temperature was increased stepwise to maintain distillation of the formed by-products. After 8 h at 230° C. the product was left to cool and discharged from the reactor.

### Synthesis of the Acid A4 (Three-Functionality)

The chemical pathway to synthesize this chemical is an esterification of adipic acid and triethanolamine. All monomers were copolymerized in a molar ratio of adipic acid:triethanolamine as 3:1. The reaction was catalyzed with 0.03 wt % of TTB. The reactor was fitted with a Vigreux column and a Dean-Stark type condenser to collect the condensation product. During the first half of the synthesis, the setup was continuously flushed with nitrogen gas to limit oxidation and facilitate transport of water vapor. While stirring, the mixture was heated to 120° C. using a heating mantle. The catalyst was added when the temperature of the mixture reached 120° C. The reaction temperature was increased stepwise to maintain distillation of the formed by-products. After 8 h at 230° C. the product was left to cool and discharged from the reactor.

The formulations of the polyurethane foam systems with the carboxy-terminated blowing agents Acid A2, A3, and A4 are show in Table 2 in the column Ex. 1, Ex. 2, and Ex. 3. In the column with the name Control 1, the formulation with Acid A1 as blowing agent is shown. Besides the carboxy-terminated blowing agent, the polyurethane foam system further included water and cyclopentane as blowing agents.

A cup test according to ASTM-D7487 was employed to determine the properties such as gel time, overall density, cup density, and core density of the polyurethane foam system. The polyol component is intensively mixed with the isocyanate component in a beaker using a laboratory stirrer (Vollrath stirrer) at a stirrer speed of 1400 revolutions per minute for a stir time of 10 seconds to make it foam up in the beaker. This so-called cup test is used to determine the cream time, the gel time, the rise time, foam density and also, where applicable, brittleness.

Cup density of the polyurethane foam was determined in the cup test by separating off the foam above the cup lip and then weighing the cup together with the remaining foam. This mass minus the mass of the empty cup (measured before foaming) divided by the volume of the cup was the cup density.

Core density of the polyurethane foam was determined by separating the core of foam from the surface portion, then cutting a cube of 3*3*3 cm dimension and weighing the cubes.

TABLE 2
Recipes and properties of polyurethane foam systems

| | | | |
|---|---|---|---|
| Control 1 | Ex. 1 | Ex. 2 | Ex. 3 |

A Component

| | | | | |
|---|---|---|---|---|
| Polyol 1 (g) | 30 | 30 | 30 | 30 |
| Polyol 2 (g) | 37 | 37 | 37 | 37 |
| FR agent TCPP (g) | 20 | 20 | 20 | 20 |
| Silicone surfactant (g) | 3 | 3 | 3 | 3 |
| HPTAF (g) | 2 | 2 | 2 | 2 |
| DMAEMAE (g) | 0.3 | 0.3 | 0.3 | 0.3 |
| Polycat ® 46 (g) | 0.3 | 0.3 | 0.3 | 0.3 |
| Acid A1 (g) | 10 | — | — | — |
| Acid A2 (g) | — | 10 | — | — |
| Acid A3 (g) | — | — | 10 | — |
| Acid A4 (g) | — | — | — | 10 |
| Water (g) | 1 | 1 | 1 | 1 |
| c-Pentane (g) | 9 | 9 | 9 | 9 |
| Total (g) | 112.6 | 112.6 | 112.6 | 112.6 |

B Component

| | | | | |
|---|---|---|---|---|
| PMDI (g) | 180 | 180 | 180 | 180 |
| Isocyanate index | 255 | 260 | 256 | 245 |

Reaction Properties

| | | | | |
|---|---|---|---|---|
| Gel time (s) | 78 | 60 | 72 | 58 |
| Cup density (kg/m³) | 50.0 | 50.3 | 50.5 | 50 |
| Core density (kg/m³) | 40.8 | 41.3 | 41.0 | 41.5 |

From Table 2, it could be indicated that the formulation with Acid A2, A3, or A4 expressed an improved and accelerated reaction compared with the formulation with Acid A1. The gel time was much shorted in Example 1, 2, or 3 than that in Control 1.

These four formulations were used to prepare a box mold foam with the size of 40 cm*40 cm*9 cm. During the reaction, the temperature in the mold was controlled at 50° C. 30 minutes after injecting the foam into the mold the cured foam was demolded. The properties of the foams are listed in Table 3.

TABLE 3
Properties of foams

| | | | |
|---|---|---|---|
| Control 1 | Ex. 1 | Ex. 2 | Ex. 3 |

Properties for foams under 50° C., 30 min demolding

| | | | | |
|---|---|---|---|---|
| Overall density (kg/m³) | 54.9 | 54.9 | 53.8 | 53 |
| Core Density (kg/m³) | 48.5 | 47.7 | 47.8 | 47 |
| Compressive strength (MPa) | 0.36 | 0.373 | 0.383 | 0.386 |
| Elastic modulus (MPa) | 12.79 | 13.58 | 13.51 | 13.86 |
| Thermal conductivity (mW/m*K) | 24.12 | 23.84 | 24.02 | 24.02 |
| Close cell content (%) | 89 | 90 | 89 | 90 |
| Tensile (N/mm²) | 0.4 | 0.38 | 0.42 | 0.43 |
| Water absorption (%) | 2 | 2.1 | 2.1 | 2.1 |
| Dimensional stability | −1.8 | −1.9 | −2.08 | −1.5 |
| @80° C. length (%) | | | | |
| B2 (cm) | 13/13/14 | 12/12/12 | 13/13/13 | 12/12/12 |
| LOI (%) | 24.2 | 24.7 | 24 | 24.5 |

Foam density of the Examples was slightly lower than that of Control 1, suggesting good blowing efficiency of Acids A2 through A4. It can be inferred that the elastic modulus of foams prepared from polyurethane foam system with the carboxyl-terminated blowing agent provided in the present disclosure improved considerably, compared with that of Control 1.

To further evaluate influence of blowing agents on the reactivity, a different polyurethane foam system was used. Usage of polyether polyol was reduced, compared with the examples and control example in Table 3. The isocyanate index increased to about 370. The formulations and results are summarized in Table 4.

TABLE 4
Recipes and properties of polyurethane foam systems

| | |
|---|---|
| Control 2 | Ex. 4 |

A Component

| | | |
|---|---|---|
| Polyol 1 (g) | 37.3 | 37.3 |
| Polyol 2 (g) | 6.6 | 6.6 |
| TCPP (g) | 25 | 25 |
| TEP (g) | 8 | 8 |
| Silicone surfactant (g) | 2.2 | 2.2 |
| HPTAF (g) | 6 | 6 |
| DMAEMAE (g) | 0.9 | 0.9 |
| Polycat ® 46 (g) | 0.9 | 0.9 |
| Acid A1 (g) | 8.8 | — |
| Acid A3 (g) | — | 8.8 |
| Water (g) | 1 | 1 |
| c-Pentane (g) | 9 | 9 |
| Total (g) | 112.6 | 112.6 |

B Component

| | | |
|---|---|---|
| PMDI (g) | 188 | 188 |
| Isocyanate index | 372 | 375 |

Reaction Properties

| | | |
|---|---|---|
| Gel time (s) | 73 | 68 |
| Cup density (kg/m³) | 46 | 46 |
| Core density (kg/m³) | 38 | 36.3 |

Compared with Acid A1, the carboxyl-terminated blowing agent Acid A3 shown benefit with respect to reactivity of the polyurethane foam system, as indicated by the shortened gel time.

1. A carboxyl-terminated blowing agent comprising at least one structure represented by Formula (I): 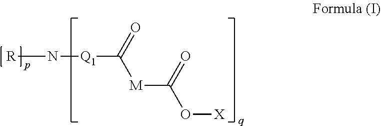
wherein
p is 0 or 1, q is 2 or 3, and the sum of p and q is 3,
each R independently is an alkyl, alkenyl, alkynyl, or aryl group with 1 to 20 carbon atoms,
each Q₁ independently is a polyether moiety consisting of one or more repeating units of alkylene oxide,
each M independently is an alkylene or arylene group with 2 to 10 carbon atoms,
each X independently is hydrogen or a group represented as —[YC(O)MC(O)O]ᵥ—H, wherein each Y independently is a polyether moiety consisting of one or more repeating units of alkylene oxide, and v is an integer from 1 to 12.

2. The carboxyl-terminated blowing agent according to claim 1, wherein each M independently is a linear or branched alkyl group with 2 to 8 carbon atoms.

3. The carboxyl-terminated blowing agent according to claim 1, wherein each Q₁ independently is a polyether moiety consisting of 1 to 10 repeating units selected from the group consisting of tetramethylene oxide, ethylene oxide, propylene oxide, butylene oxide, and styrene oxide.

4. The carboxyl-terminated blowing agent according to claim 1, wherein each X independently is (EO)ₙ[(C(O)CH₂CH₂CH₂CH₂C(O)O(EO)ₙ]ₒC(O)CH₂CH₂CH₂CH₂C(O)OH, EO is ethylene oxide, n is an integer from 1 to 10, and o is an integer from 0 to 10.

5. The carboxyl-terminated blowing agent according to claim 1, wherein the carboxyl-terminated blowing agent has an acid number of 60 to 200 mgKOH/g.

6. The carboxyl-terminated blowing agent according to claim 1, wherein the molecular weight of the carboxyl-terminated blowing agent is from 200 to 2000 g/mol.

7. A polyurethane foam system comprising:
a polyol component; and
an isocyanate component,
wherein the polyol component comprises
a polyether polyol, a polyester polyol or a mixture thereof;
one or more catalysts; and
at least one blowing agent comprising the carboxyl-terminated blowing agent according to claim 1; and
wherein the polyol component includes 5 to 30 wt. % of the carboxyl-terminated blowing agent, wherein the wt. % values are based on the total weight of the polyol component.

8. The polyurethane foam system according to claim 7, wherein the polyol component includes 6 wt % to 25 wt % of the carboxyl-terminated blowing agent, based on a total weight of the polyol component.

9. The polyurethane foam system according to claim 7, wherein the isocyanate component comprises one or more component selected from the group consisting of aliphatic, cycloaliphatic, araliphatic, and aromatic isocyanates.

10. The polyurethane foam system according to claim 7, wherein the catalysts comprise one or more catalysts selected from the group consisting of amine-based catalysts and metal-based catalysts.

11. The polyurethane foam system according to claim 7, wherein the blowing agent further comprises one or more chemical blowing agents and/or physical blowing agents.

12. The polyurethane foam system according to claim 7, further comprising a flame retardant.

13. The polyurethane foam system according to claim 12, wherein the flame retardant comprises at least one phosphorus-containing flame retardant which is a derivative of phosphoric acid, polyphosphoric acid, phosphonic acid, and/or phosphinic acid.

14. The polyurethane foam system according to claim 7, further comprising a surfactant.

15. The polyurethane foam system according to claim 7, wherein the polyol component and the isocyanate component are in a weight ratio such that the isocyanate index is from 150 to 500.

16. A polyurethane foam produced from the polyurethane foam system according to claim 7.

17. A composite comprising the polyurethane foam according to claim 16.

18. The composite according to claim 17, wherein the composite comprises the polyurethane foam as a core layer.

19. A method of using the composite according to claim 17, the method comprising using the composite as a board or a panel in a cleanroom cold storage, a reefer, a roof panel, or a laminate; or as a pipe insulation in a spray pipe or an injection pipe.

20. The carboxyl-terminated blowing agent according to claim 1, wherein each M independently is a linear or branched alkyl group with 2 to 6 carbon atoms.
